(19) United States
(12) Patent Application Publication
(10) Pub. No.: US 2002/0133589 A1
(43) Pub. Date: Sep. 19, 2002

(54) DYNAMIC BANDWIDTH NEGOTIATION SCHEME FOR WIRELESS COMPUTER NETWORKS

(76) Inventors: RAJUGOPAL R. GUBBI, FAIR OAKS, CA (US); BAO NGUYEN, ROCKLIN, CA (US); NATARAJAN EKAMBARAM, RONCHO CORDOVA, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/357,462

(22) Filed: Jul. 20, 1999

Related U.S. Application Data
(63) Continuation-in-part of application No. 09/151,579, filed on Sep. 11, 1998.

(51) Int. Cl. G06F 15/173

(52) U.S. Cl. 709/225

(57) ABSTRACT

Bandwidth within a communication channel of a computer network is dynamically allocated according to bandwidth requests of devices within the computer network. Such requests may include releases of excess bandwidth in addition to requests for additional bandwidth. In some cases, the communication channel may be a wireless, spread spectrum communication channel. In general, the bandwidth may be dynamically allocated according to priorities of the requests. For example, the requests may be arranged such that those associated with isochronous transmissions within the computer network are accorded the highest priority. A table of such bandwidth allocations may be maintained (e.g., by a network master device) so as to account for bandwidth utilization within the network. Such a table may include bandwidth allocations for the various information streams according to their varying priorities. The table may then be dynamically updated according to the bandwidth requests and any bandwidth allocations made in accordance therewith.

### RELATED APPLICATION

This application is a continuation-in-part of co-pending application Ser. No. 09/151,579, entitled “Method and Apparatus for Accessing a Computer Network Communication Channel”, filed Sep. 11, 1998, by Rajugopal R. Gubbi, Natarajan Ekambaram and Nirmalendu Bikash Patra, and assigned to the Assignee of the present application.

### FIELD OF THE INVENTION

The present invention relates generally to a scheme for communications within a computer network and, in particular, to a scheme for allocating the available bandwidth of a wireless communications link used for communications between a central server or other network master device and a number of client devices.

### BACKGROUND

Modem computer networks allow for inter-communication between a number of nodes such as personal computers, workstations, peripheral units and the like. Network links transport information between these nodes, which may sometimes be separated by large distances. However, to date most computer networks have relied on wired links to transport this information. Where wireless links are used, they have typically been components of a very large network, such as a wide area network, which may employ satellite communication links to interconnect network nodes separated by very large distances. In such cases, the transmission protocols used across the wireless links have generally been established by the service entities carrying the data being transmitted, for example, telephone companies and other service providers.

In the home environment, computers have traditionally been used as stand-alone devices. More recently, however, there have been some steps taken to integrate the home computer with other appliances. For example, in so-called “Smart Homes”, computers may be used to turn on and off various appliances and to control their operational settings. In such systems, wired communication links are used to interconnect the computer to the appliances that it will control. Such wired links are expensive to install, especially where they are added after the original construction of the home.

In an effort to reduce the difficulties and costs associated with wired communication links, some systems for interconnecting computers with appliances have utilized analog wireless links for transporting information between these units. Such analog wireless links operate at frequencies commonly utilized by wireless telephones. Although easier to install than conventional wired communication links, analog wireless communication links suffer from a number of disadvantages. For example, degraded signals may be expected on such links because of multipath interference. Furthermore, interference from existing appliances, such as televisions, cellular telephones, wireless telephones and the like may be experienced. Thus, analog wireless communication links offer less than optimum performance for a home environment.

In the above-referenced co-pending application, Ser. No. 09/151,579, which is incorporated herein by reference, a computer network employing a digital, wireless communication link adapted for use in the home environment was described. That architecture included a number of network components arranged in a hierarchical fashion and communicatively coupled to one another through communication links operative at different levels of the hierarchy. At the highest level of the hierarchy, a communication protocol that supports dynamic addition of new network components at any level of the hierarchy according to bandwidth requirements within a communication channel operative at the highest level of the network hierarchy is used.

The generalization of this network structure is shown in FIG. 1. A subnet 10 includes a server 12. In this scheme, the term “subnet” is used to describe a cluster of network components that includes a server and several clients associated therewith (e.g., coupled through the wireless communication link). Depending on the context of the discussion however, a subnet may also refer to a network that includes a client and one or more subclients associated therewith. A “client” is a network node linked to the server through the wireless communication link. Examples of clients include audio/video equipment such as televisions, stereo components, personal computers, satellite television receivers, cable television distribution nodes, and other household appliances.

Server 12 may be a separate computer that controls the communication link, however, in other cases server 12 may be embodied as an add-on card or other component attached to a host computer (e.g., a personal computer) 13. Server 12 has an associated radio 14, which is used to couple server 12 wirelessly to the other nodes of subnet 10. The wireless link generally supports both high and low bandwidth data channels and a command channel. Here a channel is defined as the combination of a transmission frequency (more properly a transmission frequency band) and a pseudo-random (PN) code used in a spread spectrum communication scheme. In general, a number of available frequencies and PN codes may provide a number of available channels within subnet 10. As is described in the co-pending application cited above, servers and clients are capable of searching through the available channels to find a desirable channel over which to communicate with one another.

Also included in subnet 10 are a number of clients 16, some of which have shadow clients 18 associated therewith. A shadow client 18 is defined as a client which receives the same data input as its associated client 16 (either from server 12 or another client 16), but which exchanges commands with server 12 independently of its associated client 16. Each client 16 has an associated radio 14, which is used to communicate with server 12, and some clients 16 may have associated subclients 20. Subclients 20 may include keyboards, joysticks, remote control devices, multi-dimensional input devices, cursor control devices, display units and/or other input and/or output devices associated with a particular client 16. A client 16 and its associated subclients 20 may communicate with one another via communication links 21, which may be wireless (e.g., infra-red, ultrasonic, spread spectrum, etc.) communication links.

Each subnet 10 is arranged in a hierarchical fashion with various levels of the hierarchy corresponding to levels at which intra-network component communication occurs. At a highest level of the hierarchy exists the server 12 (and/or its associated host 13), which communicates with various clients 16 via the wireless radio channel. At other, lower levels of the hierarchy the clients 16 communicate with their various subclients 20 using, for example, wired communication links or wireless communication links such as infrared links.

Where half-duplex radio communication is used on the wireless link between server 12 and clients 16, a communication protocol based on a slotted link structure with dynamic slot assignment is employed. Such a structure supports point-to-point connections within subnet 10 and slot sizes may be re-negotiated within a session. Thus a data link layer that supports the wireless communication can accommodate data packet handling, time management for packet transmission and slot synchronization, error correction coding (ECC), channel parameter measurement and channel switching. A higher level transport layer provides all necessary connection related services, policing for bandwidth utilization, low bandwidth data handling, data broadcast and, optionally, data encryption. The transport layer also allocates bandwidth to each client 16, continuously polices any under or over utilization of that bandwidth, and also accommodates any bandwidth renegotiations, as may be required whenever a new client 16 comes on-line or when one of the clients 16 (or an associated subclient 20) requires greater bandwidth.

The slotted link structure of the wireless communication protocol for the transmission of real time, multimedia data (e.g., as frames) within a subnet 10 is shown in FIG. 2. At the highest level within a channel, forward (F) and backward or reverse (B) slots of fixed (but negotiable) time duration are provided within each frame transmission period. During forward time slots F, server 12 may transmit video and/or audio data and/or commands to clients 16, which are placed in a listening mode. During reverse time slots B, server 12 listens to transmissions from the clients 16. Such transmissions may include audio, video or other data and/or commands from a client 16 or an associated subclient 20. At the second level of the hierarchy, each transmission slot (forward or reverse) is made up of one or more radio data frames 40 of variable length. Finally, at the lowest level of the hierarchy, each radio data frame 40 is comprised of server/client data packets 42, which may be of variable length.

Each radio data frame 40 is made up of one server/client data packet 42 and its associated error correction coding (ECC) bits. The ECC bits may be used to simplify the detection of the beginning and ending of data packets at the receive side. Variable length framing is preferred over constant length framing in order to allow smaller frame lengths during severe channel conditions and vice-versa. This adds to channel robustness and bandwidth savings. Although variable length frames may be used, however, the ECC block lengths are preferably fixed. Hence, whenever the data packet length is less than the ECC block length, the ECC block may be truncated (e.g., using conventional virtual zero techniques). Similar procedures may be adopted for the last block of ECC bits when the data packet is larger.

As shown in the illustration, each radio data frame 40 includes a preamble 44, which is used to synchronize pseudo-random (PN) generators of the transmitter and the receiver. Link ID 46 is a field of fixed length (e.g., 16 bits long for one embodiment), and is unique to the link, thus identifying a particular subnet 10. Data from the server 12/client 16 is of variable length as indicated by a length field 48. Cyclic redundancy check (CRC) bits 50 may be used for error detection/correction in the conventional fashion.

For the illustrated embodiment then, each frame 52 is divided into a forward slot F, a backward slot B, a quiet slot Q and a number of radio turn around slots T. Slot F is meant for server 12-to-clients 16 communication. Slot B is time shared among a number of mini-slots B₁, B₂, etc., which are assigned by server 12 to the individual clients 16 for their respective transmissions to the server 12. Each mini-slot B₁, B₂, etc. includes a time for transmitting audio, video, voice, lossy data (i.e., data that may be encoded/decoded using lossy techniques or that can tolerate the loss of some packets during transmission/reception), lossless data (i.e., data that is encoded/decoded using lossless techniques or that cannot tolerate the loss of any packets during transmission/reception), low bandwidth data and/or command (Cmd.) packets. Slot Q is left quiet so that a new client may insert a request packet when the new client seeks to log-in to the subnet 10. Slots T appear between any change from transmit to receive and vice-versa, and are meant to accommodate individual radios' turn around time (i.e., the time when a half-duplex radio 14 switches from transmit to receive operation or vice-versa). The time duration of each of these slots and mini-slots may be dynamically altered through renegotiations between the server 12 and the clients 16 so as to achieve the best possible bandwidth utilization for the channel. Note that where full duplex radios are employed, each directional slot (i.e., F and B) may be full-time in one direction, with no radio turn around slots required.

Forward and backward bandwidth allocation depends on the data handled by the clients 16. If a client 16 is a video consumer, for example a television, then a large forward bandwidth is allocated for that client. Similarly if a client 16 is a video generator, for example a video camcorder, then a large reverse bandwidth is allocated to that particular client. The server 12 maintains a dynamic table (e.g., in memory at server 12 or host 13), which includes forward and backward bandwidth requirements of all on-line clients 16. This information may be used when determining whether a new connection may be granted to a new client. For example, if a new client 16 requires more than the available bandwidth in either direction, server 12 may reject the connection request. The bandwidth requirement (or allocation) information may also be used in deciding how many radio packets a particular client 16 needs to wait before starting to transmit its packets to the server 12. Additionally, whenever the channel conditions change, it is possible to increase/reduce the number of ECC bits to cope with the new channel conditions. Hence, depending on whether the information rate at the source is altered, it may require a dynamic change to the forward and backward bandwidth allocation.

### SUMMARY OF THE INVENTION

In one embodiment, bandwidth within a communication channel of a computer network is dynamically allocated according to bandwidth requests of devices within the computer network. Such requests may include releases of excess bandwidth in addition to requests for additional bandwidth. In some cases, the communication channel may be a wireless, spread spectrum communication channel.

In general, the bandwidth may be dynamically allocated according to priorities of the requests. For example, the requests may be arranged such that those associated with isochronous transmissions within the computer network are accorded the highest priority.

A table of such bandwidth allocations may be maintained (e.g., by a network master device) so as to account for bandwidth utilization within the network. Such a table may include bandwidth allocations for the various information streams according to their varying priorities. The table may then be dynamically updated according to the bandwidth requests and any bandwidth allocations made in accordance therewith.

Preferably, bandwidth requests associated with other than isochronous streams are satisfied according to a process wherein those of the requests associated with the device having the lowest overall bandwidth utilization are satisfied first, followed by remaining requests. The remaining requests may then be satisfied in an order according to the priorities of the streams associated therewith and on a first-come-first-serve basis thereafter.

### BRIEF DESCRIPTION OF THE DRAWINGS

The present invention is illustrated by way of example, and not limitation, in the figures of the accompanying drawings in which:

FIG. 1 illustrates a generalized network structure within which embodiments of the present invention may operate;

FIG. 2 illustrates a hierarchical arrangement for the transmission of data within a subnet according to one embodiment of the present invention;

FIG. 3 is a flow diagram illustrating a process for assessing and reporting bandwidth requirements in accordance with an embodiment of the present invention; and

FIG. 4 is a flow diagram illustrating a process for accommodating bandwidth requests according to one embodiment of the present invention.

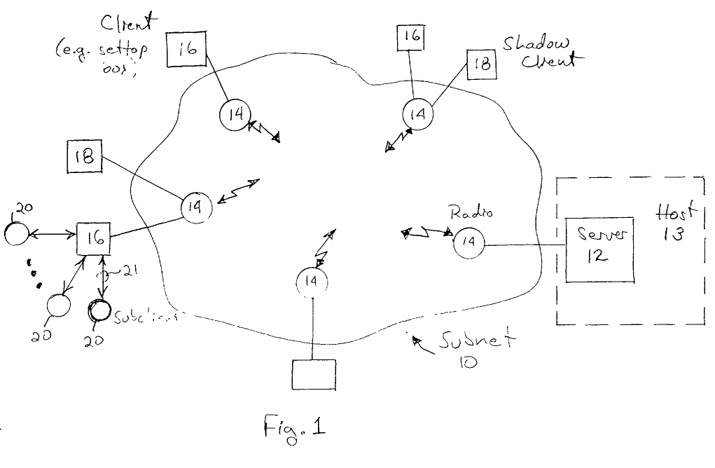

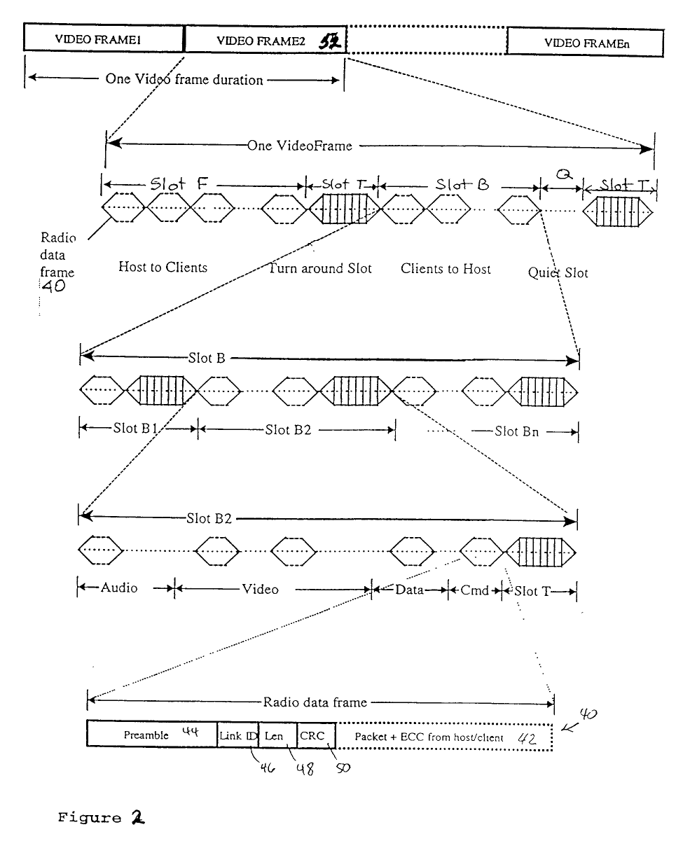

### DETAILED DESCRIPTION

Described herein is a scheme for dynamically allocating bandwidth use between a network master device (e.g., a server) and associated network clients within a communication channel of a computer network. The present scheme is generally applicable to a variety of network environments, but finds especially useful application in a wireless computer network which is located in a home environment. Thus, the present scheme will be discussed with reference to the particular aspects of a home environment. However, this discussion should in no way be seen to limit the applicability or use of the present invention in and to other network environments and the broader spirit and scope of the present invention is recited in the claims which follow this discussion.

As indicated above, some or all of the devices in a subnet 10 are able to dynamically negotiate their required bandwidth with the master device (e.g., server 12). This capability is especially useful in situations where a new isochronous stream is generated at a device (e.g., a client 16) currently allocated only a relatively low bandwidth. In such cases, the client 16 can request a change in its allocated bandwidth during its connection. Indeed, under the present scheme, any device in subnet 10 can request a bandwidth allocation change (for additional or even less bandwidth) at any time during its connection. Some of the details of the present scheme are best explained using an example.

Suppose a video source client joins the subnet 10. At the time its initial connection is established, this client may be provided a relatively large bandwidth, as such will be needed to accommodate the video information to be transmitted. Then, if at some point during the connection there is a pause or stoppage in the playback of the video, this large bandwidth is not currently needed. As a result, the video client may actually request a reduced bandwidth allocation from the network master. The bandwidth that is released by the video client can now be utilized to transport other streams from the different devices in the subnet 10. On the other hand, if the video client now needed to add a new stream, say for audio, additional bandwidth could be requested from the master and (if available) allocated accordingly.

In one embodiment of the present scheme, the master device (e.g., server 12) keeps track of all bandwidth allocations within subnet 10. If a device (e.g., a client 16) makes a request for more bandwidth than is currently available, then the master allocates only the available bandwidth. The requesting device may decide to use the allocated bandwidth if the stream to be transmitted can be accommodated within that bandwidth. For example, if the stream to be transmitted is not an isochronous stream (isochronous streams require guaranteed bandwidth), then the device may determine that the allocated bandwidth is acceptable for use. On the other hand, if the original bandwidth request was made for an isochronous stream, then the less than requested bandwidth allocation is rejected and the stream is not connected.

Several different schemes may be employed to implement the present dynamic bandwidth allocation scheme and the details of the implementation are not critical to the present invention. One such implementation that has been found to be particularly useful is as follows. Each client device of a subnet is allowed to collect statistics for the required bandwidth of each of its streams, averaged over a period of time. These bandwidth requirements are divided into four groups according to the priority of the streams (Isochronous, High, Medium and Low). Each device then compares its averaged bandwidth requirements within each priority class to its currently allocated bandwidths (e.g., that may be initially negotiated when the device joins the subnet). If the required bandwidth is less than the allocated bandwidth, then the device releases the excess bandwidth, for example by sending a notification message to the master device. On the other hand, if the required bandwidth exceeds the currently allocated bandwidth, a request for more bandwidth is sent to the master.

At the master device, requests from all the devices in the subnet are collected and compared against the total available bandwidth for the subnet. If the currently allocated bandwidth already equals the available bandwidth (after taking into account any bandwidth being released by any of the network clients) requests for additional are rejected and the respective client devices are so notified. If, however, additional bandwidth is available, requests for additional bandwidth are allocated as follows. First, requests for additional bandwidth to transport isochronous streams are allocated. If additional bandwidth is still available after these requests have been satisfied, the requests for high, medium and low priority streams are visited in that order. Within any of the stream priority levels, the bandwidth is allocated in the following order of priority:

1. Requests from the device with the current overall lowest bandwidth allocation are satisfied first;

2. Requests from the device with lowest current bandwidth allocation for the current priority level are satisfied next; and

3. The remaining requests are satisfied on a first-come-first-serve basis.

For purposes of the present bandwidth allocation scheme, the master device maintains a table listing the allocated bandwidth (e.g., in Mbits/sec) for each stream priority level at every client device, the requested bandwidth for each stream priority at every device and the time of the request as shown in Table 1. These values can be compared against the actual available bandwidth (which may be stored separately or in the same table in a separate entry) when new requests for bandwidth are made and/or when excess bandwidth is released. Each time new requests are made/satisfied and/or when excess bandwidth is released, the bandwidth allocation table (which may be stored in memory at the host 13 or server 12) is updated. For bandwidth allocation purposes, the requirements of master device are treated that same as those for any other device in a subnet.

TABLE 1

| | | | | |
|---|---|---|---|---|
| | | Allocated | Required | |
| | | Bandwidth | Bandwidth | Time of |
| Device | Priority Level | (Mbps) | (Mbps) | Request |

| | | |
|---|---|---|
| Device 0 | Isochronous | |
| (Master) | High | |
| | Medium | |
| | Low | |
| Device 1 | Isochronous | |
| (Client 1) | High | |
| | Medium | |
| | Low | |
| | | • |
| | | • |
| | | • |
| Device N | Isochronous | |
| (Client N) | High | |
| | Medium | |
| | Low | |

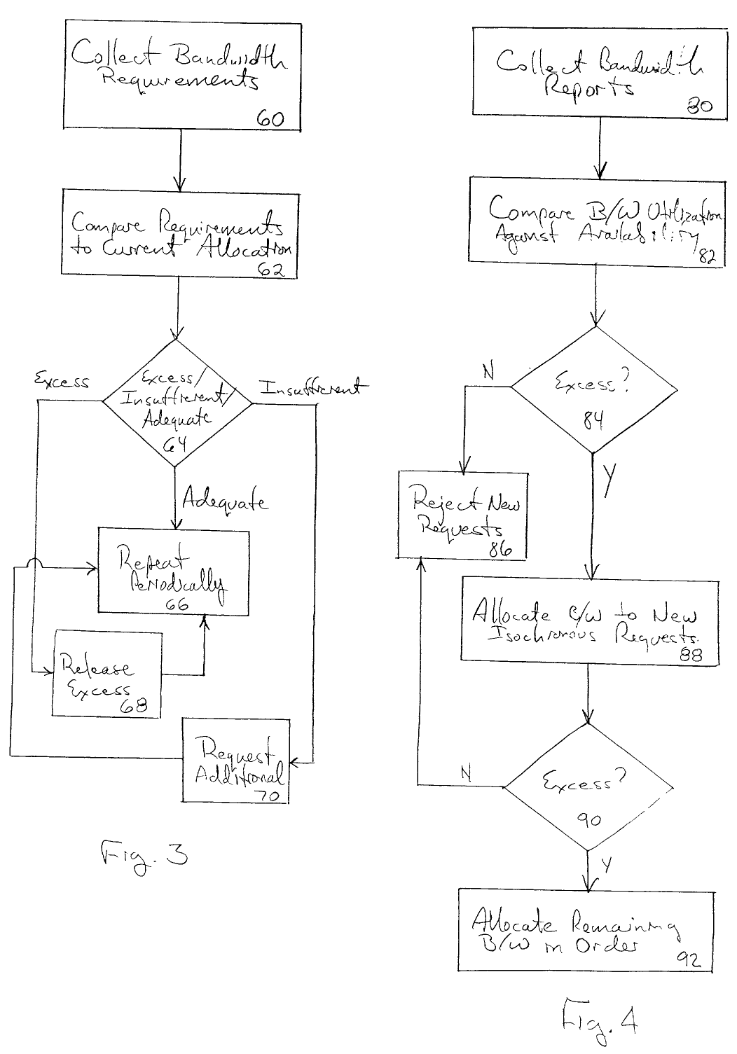

To summarize the above processes, each network device periodically assesses its bandwidth requirements/allocations, as shown in FIG. 3. Initially, each device determines its average bandwidth requirements in each of the above-mentioned priority classes (step 60). These requirements are then compared against the current bandwidth allocations (step 62) and a determination is made as to whether the current allocations are adequate, include excess bandwidth or provide for insufficient bandwidth (step 64). If the current allocations are adequate, no further action is needed, and the device repeats the bandwidth assessment periodically (step 66). If the current allocations are more than what is needed, the device may release excess bandwidth (step 68) by informing the network master of the situation and requesting a new, reduced bandwidth allocation. If, however, the current allocations are insufficient, the device transmits a request for additional bandwidth to the master (step 70).

As for the network master, the dynamic bandwidth allocations and requests are managed as shown in FIG. 4. The bandwidth reports (e.g., requests for new allocations) are received from the network devices (including the master's own reports) (step 80) and compared against the current utilization scheme, after taking into account any bandwidth being released (step 82). The result of this comparison is checked to determine whether any excess bandwidth remains (step 84). If not, the requests for additional bandwidth are rejected (step 86).

If, however, additional bandwidth is available in the subnet, the requests for new bandwidth to accommodate isochronous streams are satisfied up to the total available bandwidth (step 88). If all of these requests are satisfied (or if there are none), a check is made to see if any additional bandwidth is available (step 90) and, if so, the remaining requests are satisfied in the order discussed above (step 92). Of course, if no bandwidth is available, or at the point it is exhausted, any remaining requests are rejected. This process may be repeated periodically as new bandwidth reports are received and analyzed.

Although not shown in detail in the figure, it should be appreciated that the bandwidth reports could be received in response to a request by the master therefor. For example, if the master device needs to accommodate a high priority stream from a device, the master could request bandwidth reports to determine which device(s) has/have available bandwidth that could be released to accommodate the high priority stream. With such information (which could even indicate that the device with the high priority stream has other bandwidth, e.g., associated with another (low priority) stream that could be released) the master can begin negotiations to free up bandwidth to accommodate the high priority stream.

Thus, a scheme for dynamically allocating bandwidth within a computer network communication channel has been described. Although discussed with reference to certain illustrated embodiments, the present invention should not be limited thereby. Instead, the present invention should only be measured in terms of the claims that follow.

What is claimed is:

1. A method, comprising dynamically allocating bandwidth within a communication channel of a computer network according to bandwidth requests of devices within the computer network.

2. The method of claim 1 wherein the bandwidth requests include releases of excess bandwidth.

3. The method of claim 2 wherein the communication channel comprises a spread spectrum communication channel.

4. The method of claim 3 wherein the communication channel further comprises a wireless communication channel.

5. The method of claim 1 wherein the bandwidth is dynamically allocated according to priorities of the requests.

6. The method of claim 5 wherein the priorities of the requests are arranged such that bandwidth requests associated with isochronous transmissions within the computer network are accorded highest priority.

7. The method of claim 1 wherein the bandwidth requests are made at any times during which the devices have active connections within the computer network.

8. The method of claim 1 wherein dynamically allocating bandwidth comprises renegotiating bandwidth for a low priority stream associated with one of the devices to accommodate a high priority stream associated with the same or another of the devices.

9. A method, comprising maintaining a table of bandwidth allocations for devices of a computer network so as to account for bandwidth utilization within the network.

10. The method of claim 9 wherein the table is maintained by a master device within the network.

11. The method of claim 10 wherein table includes bandwidth allocations for information streams having varying priorities.

12. The method of claim 11 wherein isochronous streams are accorded highest priority within the network.

13. The method of claim 12 wherein the table is dynamically updated according to bandwidth requests by the devices within the network and allocations made in accordance therewith.

14. The method of claim 13 wherein the bandwidth requests include requests for additional bandwidth and releases of excess bandwidth.

15. The method of claim 14 wherein bandwidth requests associated with other than isochronous streams are satisfied according to a process wherein those of the requests associated with the device having the lowest overall bandwidth utilization are satisfied first, followed by remaining requests.

16. The method of claim 15 wherein the remaining requests are satisfied in an order according to the priorities of the streams associated therewith and on a first-come-first-serve basis thereafter.
